(19) United States
(12) Patent Application Publication
(10) Pub. No.: US 2004/0113078 A1
(43) Pub. Date: Jun. 17, 2004

(54) Method for assessing remaining useful life and overall quality of laminating paper

(76) Inventors: Eugenia Dessipri, Thessaloniki (GR); Georgios D. Chryssikos, Athens (GR); Vassilis Gionis, Athens (GR); Panagiotis Nakos, Thessaloniki (GR); Alkiviadis Paipetis, Athens (GR)

Correspondence Address: LADAS & PARRY, 26 WEST 61ST STREET, NEW YORK, NY, 10023, US

(21) Appl. No.: 10/466,230

(22) PCT Filed: Feb. 4, 2002
(86) PCT No.: PCT/GR02/00005

(30) Foreign Application Priority Data
Feb. 2, 2001 (GB) 0102688.9

(51) Int. Cl. G01N 21/35

(52) U.S. Cl. 250/339.12

(57) ABSTRACT

The suitability of resin-impregnated papers for composite laminates is determined by a method in which the NIR spectra are measured and compared with those of reference samples.

The present invention relates to a non-destructive method for off-line or on-line evaluation of the quality and suitability for use of laminating paper. In particular it relates to a method using NIR (Near Infra Red) spectroscopy.

The use of NIR spectroscopy to monitor various processes has been developed systematically during the last years and was assisted by the increase in speed and capacity of the computers available. This NIR technique has been applied to various industries such as the oil industry, pharmaceuticals, food industry, control of fermentation, and certain polymer manufacture. There has been the use of the system in on line and end point determinations and reaction coordination for homogeneous and heterogeneous reactions. The analysis has been carried out on liquid and vapor phase process streams. In line process monitoring on polymer systems by NIR spectroscopy is discussed by D. Fischer et al., In-line process monitoring on polymer melts by NIR-spectroscopy, Fresenius J. Anal. Chemistry, 359, 1997, p. 74-77, and by J. P. Dunkers et al, Fourier Transform Near-infrared Monitoring of Reacting Resins Using an Evanescent Wave High-Index Fibre-Optic Sensor, Applied Spectroscopy, 52 (4), 1998, p. 552-556. In particular the use of the method has been described to measure the quality of wood products such as chips, saw dust, pulp and paper (K Sjöberg et al., Spectrophotometric method to measure quality and strength parameters in trees, lumber, timber, chips, saw dust, pulp and paper, WO/9531710) and specifically in particleboard (composite board) manufacturing for monitoring raw wood quality (B. Engstrom and Mona Hedqvist, Prediction of the Properties of Board by using a spectroscopic method combined with multivariate calibration, U.S. Pat. No. 5,965,888).

In both those applications the spectroscopy is used to evaluate the raw wood or paper before mixing or impregnation with resin. The evaluation is possible presumably because the chemical composition of the wood or paper itself is determining in large its properties and can be predicted by NIR spectroscopy. In WO/9531710 it is mentioned that multivariate analysis of absorbance or reflectance data identify spectral features, so-called principal components, which are then used to model qualitative and quantitative properties of the samples. When a sample set is obtained for a number of samples with a representative spread in desired qualitative and quantitative properties, chemometrics is used to construct a calibration set and to predict unknown samples. There are several useful chemometrical methods. PCA (Principal Component Analysis, ASTM, Standard E131-90, Def of PCA, in Standard Definitions of Terms and Symbols Relating to Molecular Spectroscopy. M. F. Devaux et al., Application of multidimensional analyses to the extraction of discriminant spectral patterns from NIR spectra, Appl. Spect., 42(6), 1988, p. 1015-1019. M. F. Devaux et al., Application of principal component analysis on NIR spectral collection after elimination of interference by a least square procedure, Appl. Spect., 42(6), 1988, p. 1020-1023. P. Geladi and B. R. Kowalski, Partial Least-Squares Regression: A Tutorial, Anal. Chim. Acta., 185(1-17), 1986, p.1-32. H. Martens and T.N [symbol] S, Multivariate Calibration, 1989, John Wiley & Sons. S. Wold et al., Principal Component Analysis, Chemometrics and Intelligent Laboratory Systems, 2, 1987, p. 37-52). PLS (Partial Least Squares regression, P. Geladi and B. R. Kowalski, Partial Least-Squares Regression: A Tutorial, Anal. Chim. Acta., 185(1-17), 1986, p.1-32. M. D. Haaland and E. V. Thomas, Partial Least-Squares Methods for spectral Analyses. 1. Relation to Other Quantitative Calibration Methods and the Extraction of Qualitative Information, Anal. Chem., 30(11), 1988, p.1193-1203. H. Martens and T.N [symbol] ES, Partial Least Squares Regression (PLSR) in Multivariate Calibration, 1989, John Wiley & Sons, p.112-165).

A method for evaluating formaldehyde-based resins, their production process as well as their performance is described in Applicants PCT/GR01/00049. The present application goes one step further as it refers to the use of FT-NIR methodologies for the evaluation of paper impregnated with such resin types.

In different fields of application, FTIR spectroscopy has been reported to measure the degree of cure of resins in composite materials (Vamell et al., Method for measuring degree of cure of resin in a composite material and process for making the same, U.S. Pat. No. 5,142,151). In this reference, the infrared signal is collected by transmission, and the claimed action is possible only because the systems described are relatively transparent in the infrared range and exhibit well defined absorption peaks that can be directly related to the reacting species.

Wood-based panels or boards laminated with decorative foils, low pressure laminates (LPL) or high pressure laminates (HPL) are used for all kinds of furniture, flooring, or wall panelling applications mostly for aesthetic reasons. The laminating paper is prepared by impregnating high quality paper with formaldehyde-based resins. The paper is subsequently hot-pressed on to the wood-based panel. This technology was developed in the late 1960's as a low cost alternative to panel veneering.

The quality of the laminating film or paper and the press conditions to be applied depend to a great extent on the resin used but also on the transferring and storing conditions. The recommended lifetime for laminating paper kept at 20° C. and 65% relative humidity is three months. However, even when the actual age of the laminating paper is known there is an uncertainty as to its performance because of the major effects of temperature and relative humidity on its ageing. It is typical that the lifetime of 3 months at 20° C. reduces to a lifetime of 10 days at 40° C. Therefore, occasional changes in temperature during transportation can have detrimental effects on the quality and performance of the laminating paper. Since there is no conventional method to check the age and overall quality of the laminating paper, the latter is only judged after use by the performance. This of course can result in great losses if a problematic lot is used.

Furthermore depending on the initial quality of the laminating paper, one may have to adjust the press conditions. In order to optimize the press conditions, one has to perform several time-consuming quality tests on the boards being produced. These are all destructive and off-line tests and therefore the process of optimization is both expensive and demanding in terms of personnel available during production.

An objective of the present invention is to provide a non-destructive methodology for the fast and reliable determination and prediction of the quality of the laminating papers and their remaining useful lifetime.

Another objective of the invention is to provide an on-line method for the optimization of the pressing conditions of laminating paper based on its initial quality. Further objective is to provide a method to verify the optimization by taking into account the properties of the resulting boards.

It has surprisingly been found that NIR can be used for the determination of the overall quality of the laminating paper even though there are significant local variations within the same sheet. The interference from the spectrum of paper substrate can be surprisingly overcome with adequate spectral manipulation.

According to the present invention, a method is provided for evaluating the usability of a laminating sheet impregnated with formaldehyde-based resin in a process for producing laminated board, wherein an NIR spectrum of the sheet or a sample thereof is acquired and processed together with at least one reference spectrum to obtain a parameter indicative of said usability.

Preferably the NIR spectra of the sample are acquired in a non-destructive manner suitable for providing statistically significant information over selected regions on the surface of the specimen. Particularly the invention is applied to papers impregnated with formaldehyde-based resins especially formaldehyde resins with phenol, or urea, or melamine, or mixtures of the above, or other well-known resins.

The invention will now be illustrated in the following Examples and drawings in which:

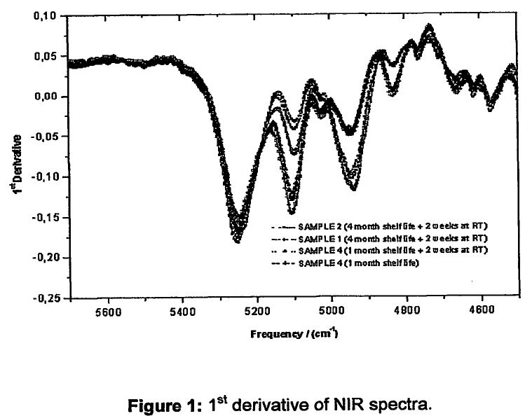

FIG. 1 is a set of 1^{st} derivative NIR spectra.

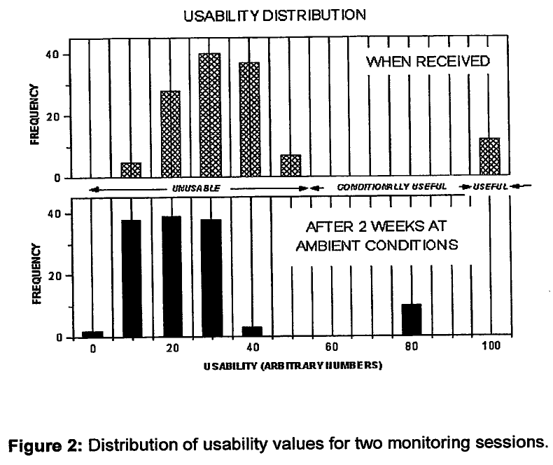

FIG. 2 is the distribution of usability values for two monitoring sessions.

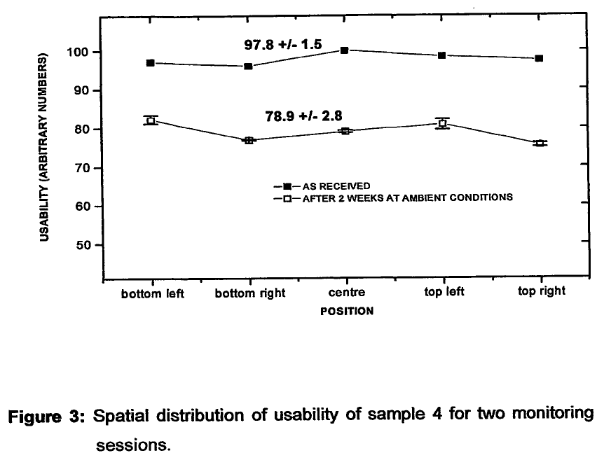

FIG. 3 is the spatial distribution of usability of sample 4 for two monitoring sessions.

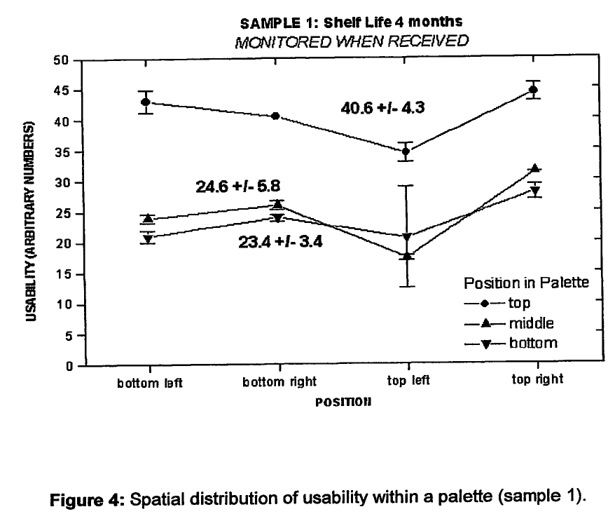

FIG. 4 is the spatial distribution of usability within a palette (sample 1).

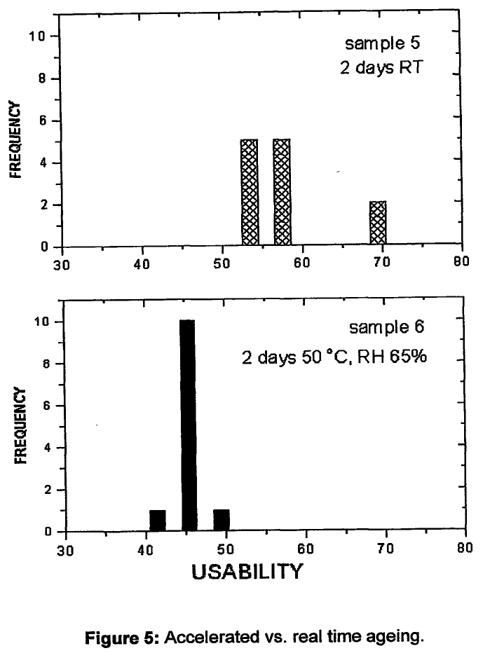

FIG. 5 is the ageing of a sample in extreme environment (accelerated ageing) compared with that kept at room temperature (real time ageing).

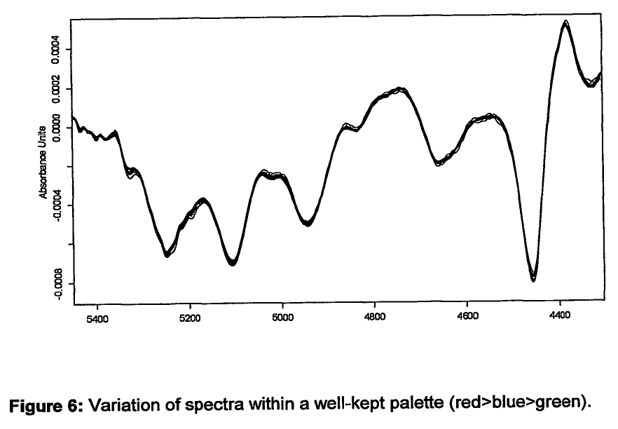

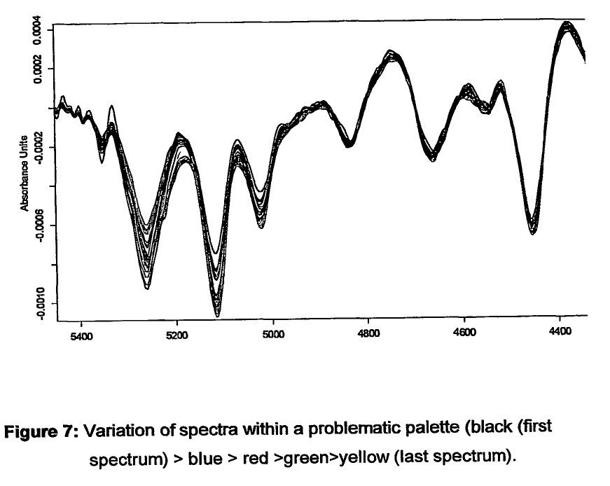

FIGS. 6 and 7 depict the variation of spectra within a well kept and a problematic palette respectively.

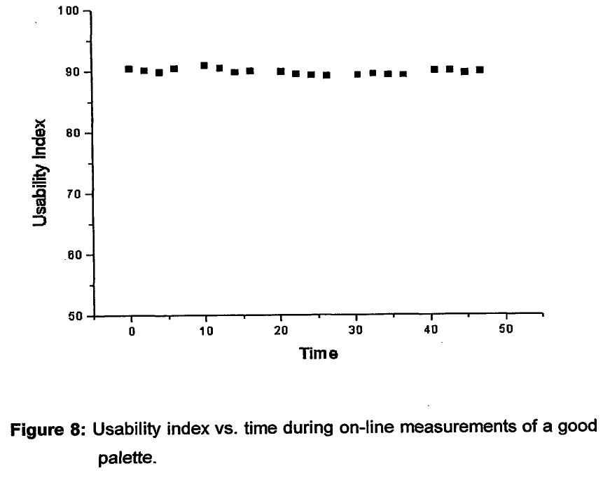

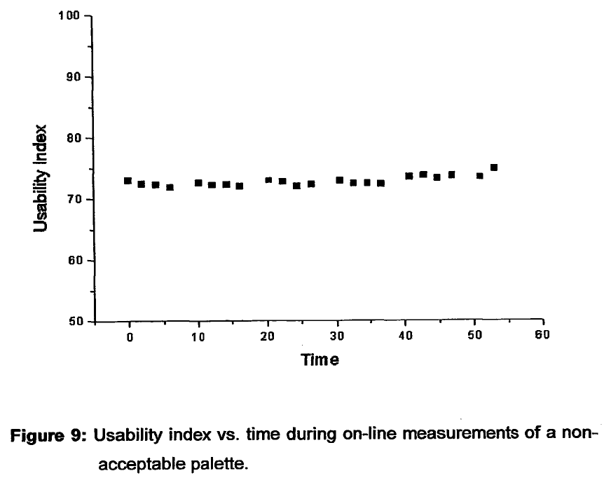

FIGS. 8 and 9 show the plot of usability index with time for an acceptable and a non-acceptable palette respectively.

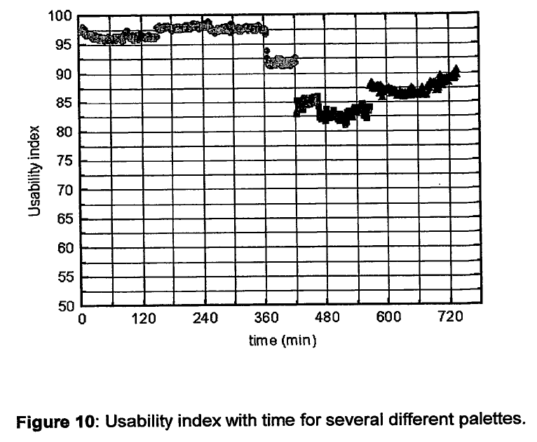

FIG. 10 shows the variation of the usability index measured on line in an industrial plant, over several different palettes.

The monitored samples consist of a laminated board (cured sample) and sets of laminating papers, which (i) qualify for production, (ii) are past their useful lifetime or have proved to be problematic, (iii) are artificially exposed to hydrothermal ageing (2 days at 50° C. and 65% relative humidity). Several sets consisted of specimens from different parts of the same palette, and are coded according to their position (e.g. ‘bottom right top’ signifies the specimen taken from the bottom right comer of the laminating sheet as we face it and from the top of the palette). All samples were NIR monitored when received, while samples 1-4 were left to age at ambient conditions for two weeks and monitored again. The sample details are shown in table 1. The third column (Quality Assessment) states whether the samples were acceptable for production according to the industrial producer.

TABLE 1

| | Shelf Life | QA | 1st NIR | 2^{nd} NIR |
|---|---|---|---|---|
| sample 1 | 4 months | no | When Received | After 2 weeks at |
| | | | | ambient conditions |
| sample 2 | 4 months | no | When Received | After 2 weeks at |
| | | | | ambient conditions |
| sample 3 | 2 months | no | When Received | After 2 weeks at |
| | | | | ambient conditions |
| sample 4 | 1 month | yes | When Received | After 2 weeks at |
| | | | | ambient conditions |
| board | N/A | N/A | | |
| sample 5 | 1 month | ? | After 3 days | |
| sample 6 | 1 month | ? | After 3 days | |

Samples 1 to 3 do not qualify for board production. Sample 4 is a production sample and has been used for the manufacturing of the board. Samples 5 and 6 are from the same production batch and have been subjected to a 2-day ageing at ambient conditions and hydrothermal exposure (50° C. and 65% relative humidity), respectively.

In the examples 1-3, the samples were monitored on a Fourier transform Near Infrared Spectrometer (Bruker VECTOR 22N) equipped with an optical fiber wave-guide. The wave-guide consists of a bundle of fiber-optics, which serves to deliver and collect the signal of the sample. For examples 4 and 5, measurements were performed on-line with a Fourier transform Near-Infrared Spectrometer (Bruker MATRIX-E) designed for non-contact measurements. In this latter case, the spectrometer was placed at a distance of 17 cm above the palette used for production so that the top sheet of the palette was measured just before being positioned on top of a board for hot-pressing. A representation of the above description is included in Picture 1.

The measurements were performed using 1 min acquisition time with resolution 8 cm⁻¹. In the case of the on-line measurements, each spectrum represents an average of approximately 5 different sheets in movement that were consecutively on the top of the palette during the 1 minute acquisition.

### EXAMPLE 1

Spectral Signature as a Function of the Sample Ageing

FIG. 1 depicts the 1^{st} derivative of the acquired spectra in the frequency range of 5700 to 4500 cm⁻¹. The spectra are vector normalized according to a procedure where the average y-value of the spectrum, yₐᵥ, is calculated first over the above frequency region. This spectrum is then scaled to fulfil the expression:

$${\sum }_{i = 1}^{NPT} {( {y}_{i} - {y}_{av} )}^{2} = 1$$

where the sum, is effected over the above frequency range. The scaled spectra are then processed as described below.

The spectra from sample 2 correspond to the edge of the sample where the laminating papers were stuck together indicating partial polymerization. Sample 1 is a problematic sample and is regarded as representative of a non-qualifying laminating sheet. Sample 4 is a production sample monitored when received, as well as after ageing at room temperature for two weeks. The spectral signature of the monitored samples reveals clear and systematic differences in the spectral area of 5400 to 4800 cm⁻¹. All spectra exhibit a monotonic change relative to the extent of their ageing of the peaks at ca. 5100 cm⁻¹ and 4920 cm⁻¹. It is clear from the progression of ageing that all spectra may be scaled as a function of their usability between the two extremes, which correspond to the ‘fresh’ production sample 4 and the ‘problematic’ sample 2.

Ageing and Usability of Monitored Samples

The spectra (see FIG. 1) can be adequately scaled between two extremes to provide a measure of the residual quality of the corresponding samples. For the purpose of this example, an arbitrary usability scale is defined whereby the spectra from sample 4 monitored when received are assigned the usability value 100 and the spectra from the most problematic area of sample 2 are assigned the usability value 0. This scale is made to correspond to the Euclidean distance D between the two reference spectra:

$$D = \sqrt{{\sum }_{i}^{} {( {x}_{i} - {y}_{i} )}^{2}}$$

where xᵢ and yᵢ are the ordinate values of the spectra x and y and the sum is effected over the frequency range of interest. The spectrum xᵢ from the problematic sample 2 is assigned the value 0 and the spectrum yᵢ from sample 4 is assigned the value 100. The unknown spectrum zᵢ is interpolated between the spectra xᵢ and yᵢ to fulfil the relationship zᵢ=(100−a)xᵢ+ayᵢ where a is the usability index of the sample. The distribution of these calculated usability values of all samples, and for both monitoring sessions, is shown in FIG. 2. The invention can be readily extended by the introduction of chemometrics, which will link the acquired spectra with the optimal pressing conditions and the quality of the final product, after on-site training during industrial production.

The two histograms depict an obvious ageing effect stemming from the 2-week room temperature storage of the samples. The ‘fresh’ sample is ageing rapidly falling by ca. 20 usability units in two weeks, whereas the distributions of the ‘unusable’ samples are deteriorating at a much slower rate: the centre of the distribution is falling by ca. 10 usability units. This behaviour implies a type of deterioration, with an initial rapid fall of usability, which tends to a plateau.

The interesting observation lies in the fact that the useful and unusable ranges are clearly defined and separated by ca. 50 usability units. There is a lower limit of usability value, above which laminating papers can be used for production. Arguably, this limit can be further reduced by adequately modifying the pressing conditions. Below this “conditional usability” range, the laminating papers are unusable.

### EXAMPLE 2

Spatial Distribution of Ageing

FIG. 3 depicts the range of usability values determined on sample 4, with reference to the position of the specimen in the palette, and as a function of ageing at ambient conditions. Overall, the sample has deteriorated by ca. 20 usability units.

An example of preferential deterioration of laminating papers in a specific palette can be seen in FIG. 4, where the usability of sample 1 from different places of the same palette is shown. Sample 1 had a shelf life of 4 months when monitored for the first time. The sample deterioration is more pronounced at the bottom of the palette. This may be attributed to factors such as moisture absorption, and clearly indicates that local environmental changes may affect the paper quality. In addition, we observe a further deterioration of the top left side, which is consistent throughout the height of the palette. Another interesting observation concerns the spread of the data in the particular side (c.f. the error bars in FIG. 4), which may be explained by the fact that there is damage nucleation, which extends radially on the surface of the paper, which, at sites with extensive damage, is affecting the statistics of our measurement.

### EXAMPLE 3

Ageing in ‘Extreme’ Conditions

FIG. 5 shows the dependence of the usability index on different ageing conditions. Samples 5 and 6 are from the same sheet. Sample 6 (red) was kept for 2 days at 50° C. and 65% relative humidity and is compared to sample 5 (green), which has been left at ambient conditions for the same period of time. The width of the distribution of measurements made on sample 5 gives a strong indication of the effect of spatial/storing parameters. Hydrothermal ageing results to a much narrower distribution centred at a lower value of usability.

### EXAMPLE 4

Differences Within the Same Palette

On-line monitoring has allowed the evaluation of differences in sheets of the same palette. These should be mainly due to storage conditions. A well-stored palette should have the same high quality paper from the top to the bottom. An example of the spectra obtained from such a palette is shown in FIG. 6. Very small differences in the spectra are observed with the position in the palette.

On the other side, large variations in the spectra of the paper from one palette are most probably indicative of problematic storage. An example is shown in FIG. 7 where the quality of the paper is better in the middle rather than the top or bottom of the palette.

### EXAMPLE 5

On Line Monitoring of Palettes Using the Usability Index

Monitoring of the laminating paper can be performed on line as described before. In such a case, the methodology is designed to translate the spectra into numbers (usability index) that quantify their quality. The result is a plot of the usability index with time that should be stable. Depending on the type of paper there is a minimum usability index that can give acceptable quality. FIGS. 8 and 9 show such plots of usability index for an acceptable and a non-acceptable palette respectively.

In the case that the paper quality is not acceptable as in FIG. 9 the palette has to be removed from production. The advantage of the on line evaluation is that detection of the problematic palette is performed very quickly and therefore the waste in time and material is minimized.

FIG. 10 shows the usability index with time as the palettes are changing. Changes in quality from one palette to another can be detected easily. Occasionally, the usability index is found to vary within the same palette. These variations prompt the operator to change the pressing conditions accordingly.

1. A method of evaluating the usability of a laminating sheet impregnated with formaldehyde-based resin in a process for producing laminated board, wherein an NIR spectrum of the sheet or a sample thereof is acquired and processed together with at least one reference spectrum to obtain a parameter indicative of said usability.

2. A method according to claim 1, wherein the NIR spectrum is processed with chemometrical methods such as Principal Component Analysis and Partial Least Squares regression.

3. A method according to claim 1 or 2, wherein said usability parameter is derived from a derivative of said NIR spectrum.

4. A method according to claim 1 or 2, wherein said parameter is derived from a comparison of peak amplitude in said NIR spectrum at one or more of 4920 cm⁻¹ and 5100 cm⁻¹ with at least one standard peak amplitude.

5. A method according to claim 4, wherein said parameter is derived from a comparison of the peak amplitude of a first derivative of said NIR spectrum.

6. A method according to any preceding claims, wherein said NIR spectrum is acquired in non-contact fashion from predetermined spaced apart regions of said sheet.

7. A method according to any preceding claim, wherein said formaldehyde-based resin is a phenol-formaldehyde, a urea-formaldehyde, a melamine-formaldehyde resin or their mixtures.

8. A method of producing laminated board wherein laminating sheet material is evaluated by a method as claimed in any preceding claim and either used in the process or rejected in dependence of the value of said usability parameter.

9. A method according to claim 8, wherein laminating conditions used in said process are adjusted in dependence upon borderline values of said usability parameter adjacent to an acceptance/rejection threshold.

10. A method of evaluating the inability of resin-impregnated laminating sheet substantially as described hereinabove with reference to the Examples.
